(19) United States
(12) Patent Application Publication
(10) Pub. No.: US 2014/0109761 A1
(43) Pub. Date: Apr. 24, 2014

(54) AXIAL PUMP HAVING STRESS REDUCED PORT PLATE

(71) Applicant: CATERPILLAR INC., Peoria, IL (US)

(72) Inventors: Jeremiah C. JOHNSON, Saint John, IN (US); Wayne E. FRITZ, Manhattan, IL (US)

(73) Assignee: CATERPILLAR INC., Peoria, IL (US)

(21) Appl. No.: 13/655,810

(22) Filed: Oct. 19, 2012

(51) Int. Cl. F04B 1/20; F04B 53/00; F04B 1/26; F15B 15/20

(52) U.S. Cl. 91/405; 91/499; 92/85 B

(57) ABSTRACT

A port plate is disclosed for use with an axial pump. The port plate may have a cylindrical plate member with a head-end face and a piston-end face located opposite the head-end face, at least one inlet port formed within a first half of the plate member and extending from the head-end face through the piston-end face, and at least one outlet port formed within a second half of the plate member and extending from the head-end face through the piston-end face. The port plate may also have at least one timing hole formed within the plate member at a leading end of the at least one outlet port and passing from the head-end face through the piston-end face, and an arcuate spherical groove extending from the at least one timing hole to the at least one outlet port.

### TECHNICAL FIELD

The present disclosure relates generally to an axial pump, and more particularly, to an axial pump having a port plate with reduced stress loading.

### BACKGROUND

An axial pump includes a plurality of pistons annularly arranged within a cylindrical barrel around a common shaft. The pistons press up against an inclined pressure plate, also known as a swashplate or wobble plate. The shaft extends from the barrel through a pump housing and is driven to rotate the barrel. As the barrel rotates, the pistons also rotate and are caused to reciprocate within the barrel by engagement with the pressure plate. A port plate having one or more inlet ports and one or more outlet ports is positioned at an end of the barrel opposite the pressure plate. As the pistons rotate and reciprocate, openings at the end of each piston align with the inlet and outlet ports in the port plate to either draw in fluid (e.g., as the piston extends from the barrel) or to push out fluid at an elevated pressure (e.g., as the piston retracts back into the barrel).

As the pistons come into full communication with a particular port, it may be possible in some situations to generate pressure pulses within the pumping system. For example, as a piston is retracting and comes into communication with a high-pressure port, the pressure at the high-pressure port may initially be higher than the pressure at the piston. This pressure difference may cause a sudden reverse pressure pulse into the barrel, followed by a rebounding pressure pulse back out of the barrel. In some situations, these pressure pulses may propagate throughout the fluid system, causing performance instabilities, noise, and even damage.

In order to inhibit undesirable pressure pulsations from forming within a fluid system, holes, slots, and/or grooves are often cut into the faces of the port plate. These features gradually communicate each piston with the corresponding port before the piston comes into full communication with the port. In this manner, pressures at the port and at the piston may be substantially equalized before the full communication occurs.

It has been found that the pulse-reducing features described above can be stress initiators within the port plate. In particular, when the features have V-shaped or square cross-sections, stresses within the port plate at the grooves can be high enough to cause damage to the port plate.

An exemplary pump having a pulse-reducing groove is disclosed in U.S. Pat. No. 3,699,845 issued to Ifield on Oct. 24, 1972 (the '845 patent). In particular, the '845 patent discloses a pump having a port plate with a groove cut into a piston-end face of a port plate. The groove has a semi-circular cross-section and extends from recesses in the piston-end face to an end of a high-pressure port. The semi-circular nature of the groove in the '845 patent may help to reduce stresses experienced by the port plate.

While the pump of the '845 patent may provide for gradual communication and pressure equalization of a piston and port while also reducing stresses in the port plate, it may still be less than optimal. In particular, it may be difficult to accurately control formation and tolerances of the groove such that pressure oscillations in the system may be suitably dampened or eliminated.

The disclosed pump and port plate are directed to overcoming one or more of the problems set forth above and/or other problems of the prior art.

### SUMMARY

In one aspect, the present disclosure is directed to a port plate for an axial pump. The port plate may include a cylindrical plate member having a head-end face and a piston-end face located opposite the head-end face, at least one inlet port formed within a first half of the plate member and extending from the head-end face through the piston-end face, and at least one outlet port formed within a second half of the plate member and extending from the head-end face through the piston-end face. The port plate may also include at least one timing hole formed within the plate member at a leading end of the at least one outlet port and passing from the head-end face through the piston-end face, and an arcuate spherical groove extending from the at least one timing hole to the at least one outlet port.

In another aspect, the present disclosure is directed to another port plate for an axial pump. This port plate may include a cylindrical plate member having a head-end face and a piston-end face located opposite the head-end face, at least one inlet port formed within a first half of the plate member and extending from the head-end face through the piston-end face, and a plurality of outlet ports formed within a second half of the plate member and extending from the head-end face through the piston-end face. The port plate may also include a plurality of timing holes formed within the plate member at a leading end of only a leading one of the plurality of outlet ports and passing from the head-end face through the piston-end face, and an arcuate spherical groove extending from the plurality of timing holes to the leading one of the plurality of outlet ports.

In yet another aspect, the present disclosure is related to an axial pump. The axial pump may include a housing, a barrel rotatably disposed within the housing and at least partially defining a plurality of cylinder bores, and a plurality of plungers associated with the plurality of cylinder bores. The axial pump may also include a swashplate tiltable by a swivel torque to vary a displacement of the plurality of plungers relative to the plurality of cylinder bores, and a port plate configured to engage an end of the rotatable barrel opposite the swashplate. The port plate may have a cylindrical plate member with a head-end face and a piston-end face located opposite the head-end face, at least one inlet port formed within a first half of the plate member and extending from the head-end face through the piston-end face, and a plurality of outlet ports formed within a second half of the plate member and extending from the head-end face through the piston-end face. The port plate may also have a plurality of timing holes formed within the plate member at a leading end of only a leading one of the plurality of outlet ports and passing from the head-end face through the piston-end face, and an arcuate spherical groove extending from the plurality of timing holes to the leading one of the plurality of outlet ports.

### BRIEF DESCRIPTION OF THE DRAWINGS

FIG. 1 is a pictorial illustration of an exemplary disclosed pump;

FIG. 2 is a front view diagrammatic illustration of a port plate that may be used in conjunction with the pump of FIG. 1;

FIG. 3 is a cross-sectional illustration of an exemplary portion of the port plate of FIG. 2;

FIG. 4 is a another cross-sectional illustration of the port plate of FIG. 2;

FIG. 5 is a rear-view diagrammatic illustration of the port plate of FIG. 2; and

FIG. 6 is a pictorial illustration of the port plate of FIG. 2.

### DETAILED DESCRIPTION

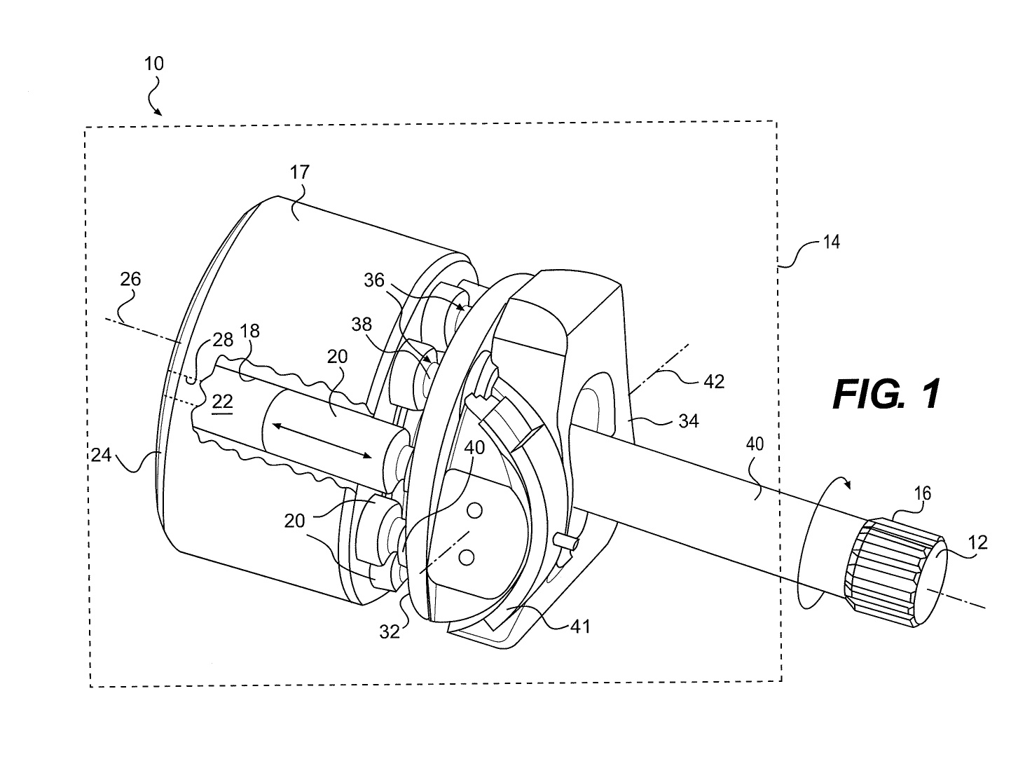

FIG. 1 illustrates an exemplary axial pump 10. Pump 10 may be, for example, a hydraulic tool pump, a transmission pump, an oil pump, a fuel pump, or a coolant pump associated with an engine-driven mobile machine. In these examples, pump 10 may be driven by the engine of the mobile machine to draw in fluid from a low-pressure sump, pressurize the fluid, and discharge the fluid at an elevated pressure to other fluid system components of the mobile machine (e.g., to injectors, valves, actuators, etc.). It is contemplated that pump 10 may alternatively be associated with a non-mobile machine, if desired.

Pump 10 may be driven via a common shaft 12. Shaft 12 may extend from one end of a housing 14 and include a splined interface 16 for connection with the engine discussed above. Housing 14 may enclose a barrel 17 that at least partially defines a plurality of cylinder bores 18 (only one shown). Pump 10 may also include a plurality of plungers 20, one plunger 20 slidingly disposed within each cylinder bore 18. Each cylinder bore 18 and each associated plunger 20 may together at least partially form a pumping chamber 22 configured to receive and discharge fluid by way of a port plate 24. It is contemplated that any number of pumping chambers 22 may be included within barrel 17 and symmetrically and radially disposed about a central axis 26. Although central axis 26 is shown as being generally coaxial with shaft 12, it is contemplated that central axis 26 may alternatively be oriented at an angle relative to shaft 12, such as in a bent-axis type pump, if desired.

Barrel 17 may be connected to rotate with shaft 12. That is, as shaft 12 is rotated by the engine, barrel 17 and plungers 20 located within cylinder bores 18 of barrel 17 may all rotate together about central axis 26. As barrel 17 rotates, individual passageways 28 associated with each pumping chamber 22 may pass by inlet and outlet ports of port plate 24 to draw in and expel pressurized fluid.

In the disclosed embodiment, pump 10 may be a swashplate-type of pump. Specifically, pump 10 may include a plunger engagement surface 32 and a fixed or tiltable base (swashplate) 34. Plunger engagement surface 32 may be located between plungers 20 and base 34 to operatively engage plungers 20 by way of a ball and socket joint 36. That is, each plunger 20 may have a generally spherical end 38, which may be biased into engagement with a cup-like socket located within a slipper foot 40. Slipper feet 40 may be configured to slide along plunger engagement surface 32, which may be connected to or otherwise integral with swashplate 34. It is contemplated that swashplate 34 may alternatively be replaced with a wobble plate or other type of pressure plate, if desired.

Swashplate 34 may be selectively tilted to vary a stroke of plungers 20 within cylinder bores 22 (i.e., a displacement of plungers 20). Specifically, swashplate 34 may be situated within a bearing member 41 and pivotal about a tilt axis 42. In one embodiment, tilt axis 42 may pass through and be substantially perpendicular to central axis 26. As swashplate 34 and connected plunger engagement surface 32 pivot about tilt axis 42, the plungers 20 located on one half of plunger engagement surface 32 (relative to tilt axis 42) may retract into their associated cylinder bores 18, while the plungers 20 located on an opposing half of plunger engagement surface 32 may extend out of their associated cylinder bores 22 by about the same amount. As plungers 20 rotate about central axis 26, plungers 20 may annularly move from the retracted side of plunger engagement surface 32 to the extended side, and repeat this cycle as shaft 12 continues to rotate.

As plungers 20 move out of cylinder bores 18, fluid may be drawn into chambers 22 by the expanding volume of chambers 22. Conversely, as plungers 20 retract back into cylinder bores 18, the fluid may be discharged from chambers 22 at an elevated pressure by the compressing volume of chambers 22. An amount of movement between the retracted and extended positions may relate to an amount of fluid displaced by plungers 20 during a single rotation of shaft 12. Because of the connection between plungers 20 and plunger engagement surface 32, the tilt angle of plunger engagement surface 32 may relate to the displacement of plungers 20. One or more pressure relief valves (not shown) located within pump 10 may affect the pressure of the fluid discharged from pumping chambers 22.

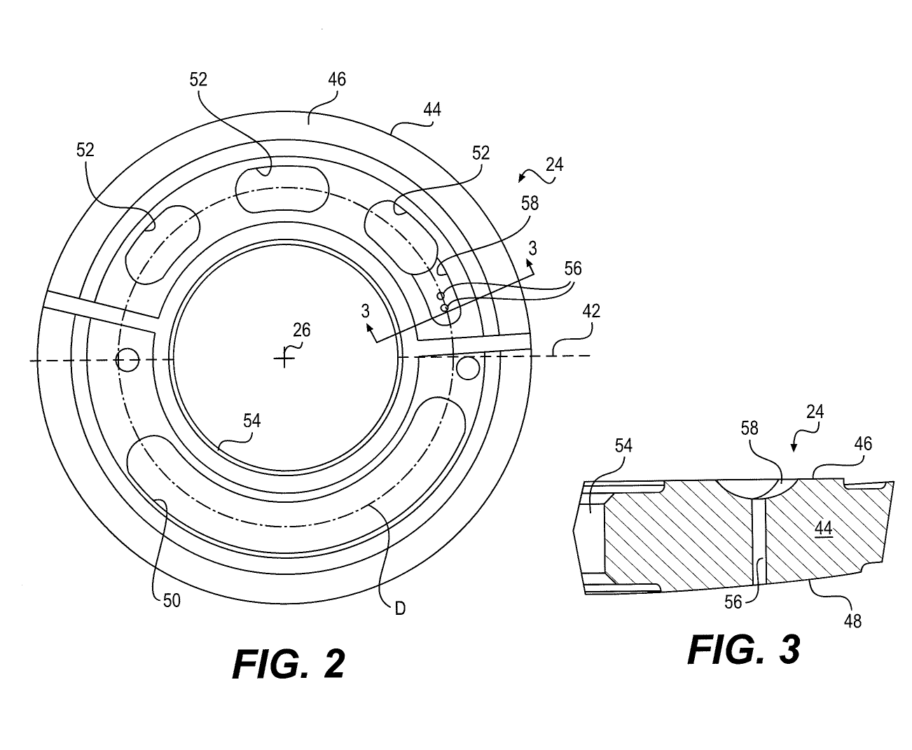

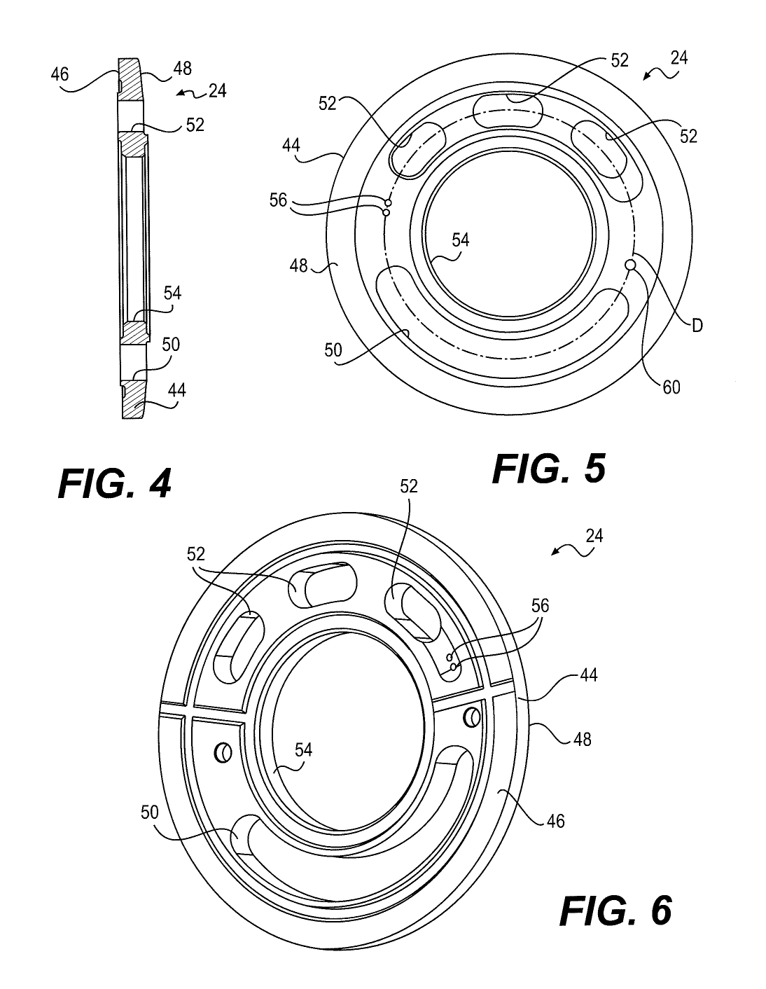

As shown in FIGS. 2-6, port plate 24 may include a ring-like cylindrical plate member 44 having a head-end face 46 (i.e., a face oriented toward a head or discharge end of pump 10) and a piston-end face 48 (i.e., a face oriented opposite head-end face 46 and toward plungers 20), and a plurality of ports formed within plate member 44 and passing from head-end face 46 through piston-end face 48. The plurality of ports may include at least one inlet port 50 formed within a first half of plate member 44 (relative to tilt axis 42) and at least one outlet port 52 formed within a second half of plate member 44. In the disclosed embodiment, port plate 24 includes one inlet port 50 and three outlet ports 52. It should be noted that any number of inlet and/or outlet ports 50, 52 may be formed within port plate 24, as desired. Plate member 44 may be fabricated from forged steel, heat treated to achieve a desired hardness, and, in some embodiments, coated with a friction reducing layer of material.

Inlet and outlet ports 50, 52 may be generally kidney-shaped (e.g., arcuate) and annularly arranged around a central opening 54. Inlet ports 50 may have a width that is about the same as a width of outlet ports 50, and inlet and outlet ports 50 may be generally aligned along a common arc diameter D that is generally concentric with central opening 54. The common arc diameter D may be radially located about halfway between an inner annular surface of central opening 54 and an outer peripheral surface of plate member 44. In the disclosed embodiment, the arc diameter D may be about 85 mm. An arc length of inlet port 50 may be about 140-160°, while an arc length of outlet ports 50 may be about 30-35°. The width of inlet and outlet ports 50, 52 may be about 10-15 mm, and more specifically about 13 mm.

One or more timing holes 56 may be formed within plate member 44, and arranged along the same arc diameter D as inlet and outlet ports 50, 52. Timing holes 56 may be located at a leading end of only the leading one of outlet ports 52, and a groove 58 may extend from timing holes 56 to the leading one of outlet ports 52 (i.e., groove 58 may communicate the leading outlet port 52 with the leading timing hole 56). Timing holes 56 may pass from head-end face 46 through piston-end face 48, while groove 58 may be formed only within head-end face 46. In the disclosed embodiment, pump 10 includes two radially-aligned timing holes 56. It should be noted, however, that pump 10 may include any number of timing holes 56.

As barrel 17 (referring to FIG. 1) and associated pumping chambers 22 rotate relative to port plate 24 (e.g., counterclockwise in FIG. 2), passageways 28 may move into and out of fluid communication with inlet and outlet ports 50, 52. Timing holes 56 and groove 58 may help to reduce a shock loading associated with these periodic communications. In particular, as passageways 28 first establish communication with one or both of timing holes 56, a limited amount and/or flow rate of fluid may pass from outlet ports 52 through groove 58 and timing holes 56 into pumping chambers 22 and vice versa. This limited flow rate of fluid may help to equalize pressures between pumping chambers 22 and outlet ports 52 before full and direct communication is established therebetween. This equalization of pressures may help to dampen, if not completely inhibit, formation of pressure pulses within pump 10 and the associated fluid system.

Timing holes 56 may be through-holes having about equal diameters and being generally aligned in a rotational direction of plungers 20. In the disclosed embodiment, timing holes 56 may have a diameter of about 1.5-3.0 mm (more specifically about 1.7 mm) and be located about 10-15° of arc length in front of the leading edge of the leading outlet port 52. When coupled with a fluid pressure of about 45 MPa or higher, timing holes 56 may be capable of passing enough fluid between outlet ports 52 and pumping chambers 22 to substantially equalize the pressures of these areas prior to full and direct communication between the areas when shaft 12 is rotating at its rated speed of, for example, about 1800 rpm.

Groove 58 may be configured to communicate timing holes 56 with the leading end of the leading outlet port 52. Groove 58, in the disclosed exemplary embodiment, may be formed by way of a ball end mill to have a generally arcuate spherical shape with a rounded end that distributes load along its length and end in a generally even manner. In the disclosed embodiment, groove 58 may have an arc length of about 15-20°, a width of about 7.5-8 mm (more specifically about 7.7 mm), a radius of about 5 mm, and a depth of about 1.8 mm (i.e., a depth that is less than about ½ of its radius). A cross-sectional area of groove 58 may be greater than a combined cross-sectional area of timing holes 56 (i.e., greater than about 4.5 mm²), such that groove 58, itself, does not create restriction on the fluid passing into and/or out of timing holes 56. It has been found that a groove flow ratio (i.e., a ratio of the width of groove 58 relative to the arc diameter D of groove 58) of about 0.05-0.1 (more specifically about 0.09) provides for a desired flow rate of fluid at a desired pressure during operation of pump 10 at rated speed. It is contemplated that, although groove 58 of the disclosed exemplary embodiment is fabricated via a ball end mill, other means of fabricating groove 58 may alternatively be utilized, if desired. In addition, although groove 58 is the only groove shown in the embodiment of FIGS. 2 and 3, it is contemplated that additional grooves may be included and/or associated with any or all of outlet ports 52, if desired.

As shown only in FIG. 5, a decompression hole 60 may be formed only in piston-end face 48. Decompression hole 60 may function similar to timing holes 52, allowing decompression of cylinder bores 18 prior to communication with inlet port 50. In this manner, the flow of fluid into cylinder bores 18 may not be disrupted. Decompression hole 60 may be fluidly connected with a leak path in housing 14 (i.e., not with inlet port 52), for example by way of a radially drilled cross-bore (not shown).

### INDUSTRIAL APPLICABILITY

The disclosed pump and port plate find potential application in any fluid system where dampening of pressure oscillations is desired. The disclosed port plate may provide for pressure dampening through equalization of pumping chamber and outlet port pressures prior to full and direct communication. The equalization may be provided by way of accurately located and easily producible timing holes 56, and groove 58 that connects timing holes 56 with the lead outlet port 52. The shape, orientation, and location of groove 58 may also function to distribute pressure loads across port plate 24, thereby extending the useful life of port plate 24. Operation of pump 10 will now be described.

Referring to FIG. 1, when shaft 12 is driven by an engine (or other mechanical power source), barrel 17 and plungers 20 disposed within cylinder bores 18 of barrel 17 may also rotate. As plungers 20 rotate about central axis 26, spherical ends 36 and paired slippers 40 thereof, riding along tilted plunger engagement surface 32, may cause plungers 20 to cyclically rise and fall in the axial direction of shaft 12 (i.e., to extend into and retract from cylinder bores 18).

The reciprocating motion of plungers 20 may function to draw fluid into pumping chambers 22 and push the fluid from pumping chambers 22 at an elevated pressure. Specifically, as pumping chambers 22 move past inlet port 50 (in the counterclockwise direction relative to FIG. 2) during the extending motion of plungers 20, the expanding volume within pumping chambers 22 may function to draw fluid in from inlet port 50 through passage 28. And as these plungers 20 move to the other side of port plate 24 (relative to tilt axis 42) and begin their retraction back into pumping chambers 22, the fluid within pumping chambers may begin to compress and increase in pressure. When plungers 20 move into alignment with timing holes 56, restricted fluid communication may be established between the leading outlet port 52 and pumping chambers 22. The communication may be established via groove 58 and timing holes 56, while the restriction may be implemented by only timing holes 56. This restricted communication may help to balance pressures between pumping chambers 22 and outlet ports 52 prior to full and direct communication (i.e., prior to axial alignment between passages 28 and outlet ports 52), thereby reducing the formation of pressure pulses upon full and direct communication.

It will be apparent to those skilled in the art that various modifications and variations can be made to the disclosed pump and port plate. Other embodiments will be apparent to those skilled in the art from consideration of the specification and practice of the disclosed pump and port plate. It is intended that the specification and examples be considered as exemplary only, with a true scope being indicated by the following claims and their equivalents.

What is claimed is:

1. A port plate for an axial pump, the port plate comprising:
a cylindrical plate member having a head-end face and a piston-end face located opposite the head-end face;
at least one inlet port formed within a first half of the plate member and extending from the head-end face through the piston-end face;
at least one outlet port formed within a second half of the plate member and extending from the head-end face through the piston-end face;
at least one timing hole formed within the plate member at a leading end of the at least one outlet port and passing from the head-end face through the piston-end face; and
an arcuate spherical groove extending from the at least one timing hole to the at least one outlet port.

2. The port plate of claim 1, wherein the at least one timing hole includes two timing holes aligned along a common arc diameter.

3. The port plate of claim 2, wherein an area of the arcuate spherical groove is equal to or greater than a combined area of the two timing holes.

4. The port plate of claim 2, wherein a flow ratio of the arcuate spherical groove is about 0.05-0.1.

5. The port plate of claim 4, wherein the flow ratio of the arcuate spherical groove is about 0.09.

6. The port plate of claim 2, wherein the arcuate spherical groove has an arc length of about 15-20°.

7. The port plate of claim 6, wherein the arcuate spherical groove has a width of about 7.5-8.0 mm.

8. The port plate of claim 7, wherein the arcuate spherical groove has a radius of about 5 mm.

9. The port plate of claim 8, wherein the arcuate spherical groove has a depth of about 1.8 mm.

10. The port plate of claim 2, wherein the arcuate spherical groove has a depth that is less than its radius.

11. The port plate of claim 1, wherein the arcuate spherical groove is the only groove formed in the port plate.

12. The port plate of claim 1, wherein:
the at least one inlet port includes a single inlet; and
the at least one outlet port includes three outlets.

13. A port plate for an axial pump, comprising:
a cylindrical plate member having a head-end face and a piston-end face located opposite the head-end face;
at least one inlet port formed within a first half of the plate member and extending from the head-end face through the piston-end face;
a plurality of outlet ports formed within a second half of the plate member and extending from the head-end face through the piston-end face;
a plurality of timing holes formed within the plate member at a leading end of only a leading one of the plurality of outlet ports and passing from the head-end face through the piston-end face; and
an arcuate spherical groove extending from the plurality of timing holes to the leading one of the plurality of outlet ports.

14. The port plate of claim 13, wherein an area of the arcuate spherical groove is equal to or greater than a combined area of the plurality of timing holes.

15. The port plate of claim 13, wherein a flow ratio of the arcuate spherical groove is about 0.09.

16. The port plate of claim 15, wherein the arcuate spherical groove has an arc length of about 15-20°.

17. The port plate of claim 16, wherein the arcuate spherical groove has a width of about 7.5-8.0 mm.

18. The port plate of claim 17, wherein the arcuate spherical groove has a depth that is less than its radius.

19. The port plate of claim 18, wherein the arcuate spherical groove has:
a radius of about 5 mm; and
a depth of about 1.8 mm.

20. An axial pump, comprising:
a housing;
a barrel rotatably disposed within the housing and at least partially defining a plurality of cylinder bores;
a plurality of plungers associated with the plurality of cylinder bores;
a swashplate tiltable by a swivel torque to vary a displacement of the plurality of plungers relative to the plurality of cylinder bores;
a port plate configured to engage an end of the barrel opposite the swashplate and having:
a cylindrical plate member with a head-end face and a piston-end face located opposite the head-end face;
an inlet port formed within a first half of the plate member and extending from the head-end face through the piston-end face;
a plurality of outlet ports formed within a second half of the plate member and extending from the head-end face through the piston-end face;
a plurality of timing holes formed within the plate member at a leading end of only a leading one of the plurality of outlet ports and passing from the head-end face through the piston-end face; and
an arcuate spherical groove extending from the plurality of timing holes to the leading one of the plurality of outlet ports.
